(19) United States
(12) Patent Application Publication
(10) Pub. No.: US 2009/0144198 A1
(43) Pub. Date: Jun. 4, 2009

(54) MONEY TRANSFER USING AN AUTOMATED BANKING MACHINE

(76) Inventor: John Hachey, Elk Grove, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/949,622

(22) Filed: Dec. 3, 2007

(51) Int. Cl. G06Q 40/00

(52) U.S. Cl. 705/44; 705/39; 705/35

(57) ABSTRACT

Money is transferred from a provider to a requester using automated banking machines. The provider accesses an automated banking machine to identify the requester to whom the money will be transferred and the amount of money to be transfer. The requester is notified of a generated confirmation code. The requester then accesses another automated banking machine to receive the money transfer amount using the confirmation code. After the requester has been verified, the requester selects where the funds are to be transferred.

### BACKGROUND OF THE INVENTION

Embodiments of the present invention relate to the transfer of money using an automated banking machine, and more particularly, to the instantaneous, secure transfer of money from one automated banking machine to another automated banking machine.

Money transfers are commonly performed when a person requires money from another on short notice. If the person who can provide the money (i.e., the provider) is not physically located near the person requesting the money (i.e., the requester), a third party may be necessary to complete the money transfer. For example, the provider could send the money in cash or check form to the requester using a delivery service (e.g., the post office or an overnight courier such as Federal Express®). The provider would need to contact the delivery service to pick up the money for delivery, or the provider would need to visit a delivery service retail location during normal business hours. Depending on the time of day and the location of the requester, delivery of the money may take longer than 24 hours. If the money was sent in cash, security problems may result due to theft. If the money was delivered to the requester in check form, the check would need to be cashed thereby further extending the time period by which the requester would have access to the requested money.

A person-to-person money transfer service, such as Western Union®, could be used to transfer money from the provider to the requester to avoid some of the problems of transferring money using a delivery service. Conventionally, the provider would enter a retail location of the money transfer service during operating hours. The provider would present the funds necessary to cover the amount to be transferred and any transaction processing fees. Alternatively, the provider could initiate the money transfer electronically using a computer. The requester would then enter another retail location of the money transfer service during operating hours to access the money. However, the requester may not have instant access to the transferred money because the retail location may not be open when the money is transferred. The requester would need to wait until operating hours to access the transferred money. Furthermore, money transfer services commonly charge high processing fees to transfer money (e.g., 10% of the transfer amount).

Embodiments of the invention address these and other problems.

### SUMMARY THE OF INVENTION

Embodiments of the invention are directed to the transfer of money from one automated banking machine to another automated banking machine. A provider (e.g., someone who will be providing the funds) accesses an automated banking machine to identify a requester (e.g., someone who will receive the funds) to whom the money will be transferred and the amount of money to transfer. The provider informs the requester of a generated confirmation code. The requester then accesses another automated banking machine to receive the amount of money transferred using the confirmation code. After the requester has been verified, the requester selects where the funds are to be transferred.

One embodiment of the invention is directed to a method of transferring funds using an automated banking machine. A fund amount to transfer and a requester identifier are received, and a confirmation code is provided. A requester and the confirmation code are verified when the requester accesses an automated banking machine. The fund amount is then transferred from a provider to the requester.

Another embodiment of the invention is directed to an automated banking machine that includes a receiving module, a confirmation code generation module, and a transfer module. The receiving module receives a fund amount to transfer and a requester identifier. The confirmation code generation module provides a confirmation code. Verification of a requester and the confirmation code is attempted when the requester accesses a different automated banking machine. The transfer module transfers the fund amount from a provider to the requester when the requester and the confirmation code are verified.

Another embodiment of the invention is directed to a method of transferring funds using a first automated banking machine and a second automated banking machine. The method includes receiving a fund amount to transfer from a provider to a requester. The fund amount to transfer is received from a first automated banking machine. An attempt is made to verify a requester and a confirmation code when the requester accesses a second automated banking machine. In the event that the requester and the confirmation code are verified, the fund amount is transferred from the provider to the requester.

Another embodiment of the invention is directed to a computing device coupled to a first automated banking machine and a second automated banking machine. The computing device includes a receiving module, a verification module, and a transfer module. The receiving module receives a fund amount to transfer from a provider (e.g., using a provider account) to a requester (e.g., using a requester account). The fund amount to transfer is received from the first automated banking machine. The verification module attempts to verify a requester and a confirmation code when the requester accesses the second automated banking machine. The transfer module transfers the fund amount from the provider to the requester when the requester and the confirmation code are verified.

Another embodiment of the invention is directed to a method of transferring funds using an automated banking machine. The method includes requesting a fund amount to transfer from a provider to a requester. The request is received at an automated banking machine. A confirmation code is received from the automated banking machine and provided to the requester. The requester and the confirmation code are verified when the requester accesses a different automated banking machine. The fund amount is then transferred from the provider to the requester.

These and other embodiments of the invention are described in further detail below.

### BRIEF DESCRIPTION OF THE DRAWINGS

FIG. 1 shows a diagram of a system for transferring money from a first automated banking machine to a second automated banking machine according to an embodiment of the invention.

FIG. 2 shows a block diagram of some components of a central computer according to an embodiment of the invention.

FIG. 3 shows a block diagram of some components of an automated banking machine according to an embodiment of the invention.

FIG. 4 shows a diagram of a process for transferring money from a first automated banking machine to a second automated banking machine according to an embodiment of the invention.

FIG. 5 shows a flowchart illustrating a method for initiating a money transfer at an automated banking machine according to an embodiment of the invention.

FIG. 6 shows a flowchart illustrating a method for using an automated banking machine for accessing transferred money according to an embodiment of the invention.

### DETAILED DESCRIPTION

One embodiment of the invention is directed to the transfer of money from a first automated banking machine to a second automated banking machine. The money is transferred from a provider to a requester. The requester may initiate the money transfer by contacting the provider (e.g., by phone, email, text message, etc.) and requesting money. The requester also provides the provider with one or more requester identifiers. For example, the requester identifier may be at least a portion of the requester's account number such as the last four digits of the account number of requester's debit or credit card, a security code associated with the requester's debit or credit card (e.g., the card verification value (CW)), or at least a portion of a requester identification number such as the last four digits of the requester's social security number, the requester's phone number, the requester's street address, the requester's zip code, etc.

The provider may then access a first automated banking machine at a first location (e.g., in New York City) using a portable consumer device such as a valid credit card or a debit card and a corresponding security code (e.g., a personal identification number). Other portable consumer devices that can interface with the first automated banking machine include key fobs, wireless phones, PDAs (personal digital assistants), laptop computers, etc. An additional security code may optionally be required (e.g., the last four digits of the provider's social security number) to proceed with the money transfer process.

Once the provider has access to the first automated banking machine, the provider may select a “Send Money” indicator, or other indicator on a main screen of the first automated banking machine to initiate the process of sending money to the requester.

At this point, a time period may be initiated. The time period may limit the amount of time that the requester has to obtain the amount of money that is transferred by the provider. This is explained in more detail below.

The provider may then be prompted by the first automated banking machine to select the amount of money to transfer to the requester and to select which account the money is to be transferred from. For example, the provider may select a checking account, a savings account, a credit account or any other account accessible by the first automated banking machine.

The first automated banking machine may then prompt the provider to identify the person to whom the money will be transferred. The provider may identify the requester using at least one requester identifier (e.g., at least a portion of the requestor's account number such as the last four digits of the requester's debit or credit card account number, or at least a portion of a requestor identification number such as the last four digits of the requester's social security number, the requester's phone number, the requester's street address, the requester's zip code, etc.).

In some cases, the provider is notified (e.g., via the first automated banking machine, or through another communication channel such as a wireless phone) that a transaction fee will be added to the amount of money to be transferred. The provider would be required to accept the transaction fee to confirm the money transfer.

In response to the money transfer confirmation, a confirmation code is generated. The confirmation code may be an alphanumeric code of variable length. The alphanumeric code can be seemingly random in nature, or it can be non-random in nature. Regardless of the type of confirmation code that is provided, the automated banking machine may provide the confirmation code to the provider as a print out or on a visual display. The confirmation code could also be sent to the provider's wireless phone, or could automatically be sent to the requester's wireless phone or other device that is operated by the requester.

If the confirmation code is not automatically sent to the requester, the provider contacts the requester (e.g., by phone, email, text message, etc.) to provide the confirmation code to the requester. The requester then accesses a second automated banking machine at a second location (e.g., in Los Angeles) using a portable consumer device such as a debit card or a credit card and the corresponding security code (e.g., a personal identification number, a phone number, a zip code, etc.). In one embodiment, the requester is required to access the second automated banking machine using the portable consumer device corresponding to the requester identifier (e.g., the debit or credit card having the last four digits that the provider used to identify the requester).

As noted above, a time period may have been initiated when the provider first accessed the first automated banking machine. If the time period has elapsed by the time the requester accesses the automated banking machine, the money transfer transaction will not be completed. This feature enhances security due to theft or fraud.

The requester may select “Money Transfer” and “Receive Funds” (or some other indicator) from a main screen on the second automated banking machine. The second automated banking machine then prompts the requester for the confirmation code and, optionally, an additional security code. In one embodiment, the additional security code corresponds to the requester identifier (e.g., the last four digits of the requester's social security number, a requester phone number, a requester zip code, etc.). The requester then provides this information to the second automated banking machine. A keypad on the second automated banking machine may be used to input the necessary information.

After the requester has been verified, the requester is notified by the second automated banking machine of the amount of money that has been transferred from the provider. The requester is prompted to select where the funds are to be transferred (e.g., checking account, savings account, credit account, etc.) or can select to receive the transferred amount as cash at that moment. Whether the fund amount is transferred to the requester's account or is received as cash from the second automated banking machine, the amount of money is considered to be transferred “to the requester.” Likewise, whether the amount of money is transferred from the provider's account or is input as cash when the provider is operating the first automated banking machine, the amount of money is considered to be transferred “from the provider.”

After the requester selects the destination for the transferred funds, the money transfer is complete. Thus, the transfer of money can be accomplished securely and instantaneously between two automated banking machines.

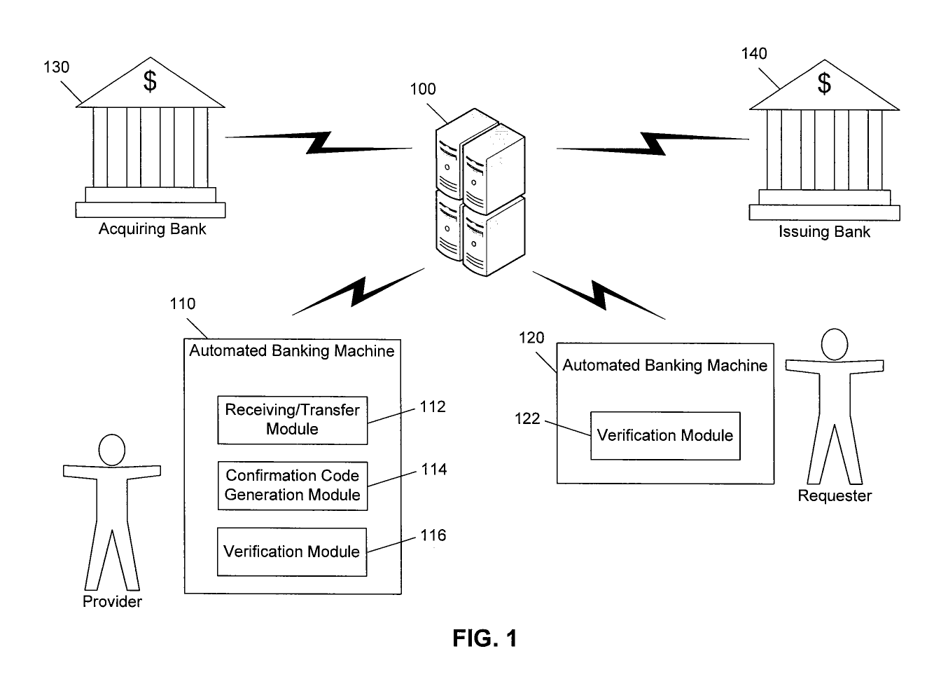

FIG. 1 shows a diagram of a system for transferring money from a first automated banking machine to a second automated banking machine according to an embodiment of the invention. A computing device such as a central computer 100 is configured to electronically couple a first automated banking machine 110 associated with a provider (i.e., the providing ATM) to a second automated banking machine 120 associated with a requester (i.e. the requesting ATM). The central computer 100 is also configured to electronically couple an acquiring bank 130 to an issuing bank 140. The central computer 100 may be any device configured to electronically couple different network elements. For example, the central computer 100 may be a server configured to communicatively couple the providing ATM 110, the requesting ATM 120, the acquiring bank 130 and the issuing bank 140 over a wide area network (WAN).

The providing ATM 110 includes a receiving/transfer module 112, a confirmation code generation module 114, and a verification module 116. As would be appreciated by one having ordinary skill in the art, the central computer 100 may be configured to include the receiving/transfer module 112, the confirmation code generation module 114 and/or the verification module 116.

The requester initiates the money transfer by contacting the provider (e.g., by phone, email, text message, etc.) and requesting an amount of money. The requester also provides the provider with one or more requester identifiers. For example, the requester identifier may be at least a portion of the requester's account number such as the last four digits of the account number of requester's debit or credit card; a security code associated with the requester's debit or credit card (e.g., CVV); or at least a portion of a requester identification number such as the last four digits of the requester's social security number, the requester's phone number, the requester's street address, the requester's zip code, etc.

The provider then accesses the providing ATM 110 at a first location using a portable consumer device such as a valid credit card or a debit card, a key fob, a wireless phone, a PDA, a laptop computer, etc. In accordance with standard ATM operations, the verification module 116 confirms the identity of the provider. For example, the verification module 116 allows the provider to access the providing ATM 110 after receiving a valid security code (e.g., a personal identification number). In one embodiment, an additional security code is required. For example, the verification module 116 may require the first four digits of the provider's social security number to permit the provider to initiate a money transfer.

The provider initiates the money transfer from the providing ATM 110. For example, the provider may select a “Send Money” indicator or some other indicator on a main screen of the providing ATM 110 to initiate the process of sending money to the requester. When the provider initiates the money transfer, a clock (not shown) may be used to initiate a predetermined time period. As described in detail below, the time period may limit the amount of time that the requester has to obtain the amount of money that is transferred by the provider.

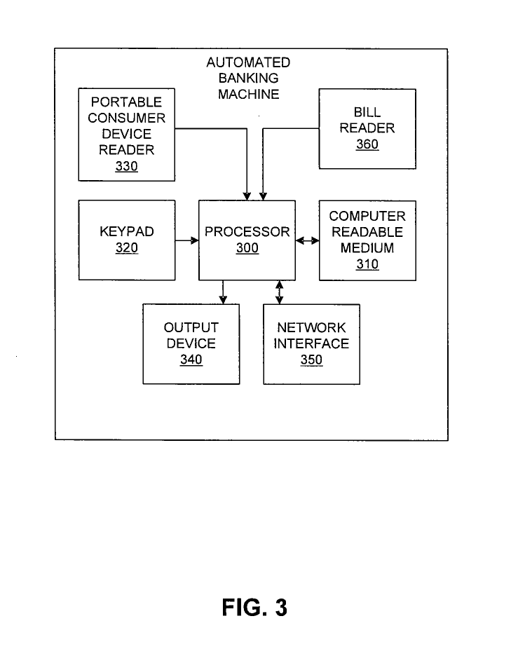

The providing ATM 110 prompts the provider to select an amount of money to transfer to the requester and to select an account the money is to be transferred from. For example, the provider may select a checking account, a savings account, a credit account or any other account accessible by the providing ATM 110. In one embodiment, the providing ATM 110 is configured with a tender reader. As described below with reference to FIG. 3, the provider may enter an amount of money to be transferred from the providing ATM 110 by directly inputting cash or a check in the tender reader.

The providing ATM 110 also prompts the provider to identify the person to whom the money will be transferred (i.e., the requester). The provider identifies the requester using at least one requester identifier (e.g., at least a portion of the requester's account number such as the last four digits of the requester's debit or credit card account number, the CVV associated with the requester's credit card, or at least a portion of a requester identification number such as the last four digits of the requester's social security number, the requester's phone number, the requester's street address, the requester's zip code, etc.).

In one embodiment, the provider is notified (e.g., via the providing ATM 110 or through another communication channel such as a wireless phone) that a transaction fee will be added to the amount of money to be transferred. The provider would be required to accept the transaction fee to confirm the money transfer.

The receiving/transfer module 112 is configured to receive the money transfer amount, the account the money is to be transferred from and the requester identifier. The receiving/transfer module 112 is also configured to transfer the money transfer amount, the account the money is to be transferred from and the requester identifier to the central computer 100 for access by the requesting ATM 120, the acquiring bank 130 and the issuing bank 140.

In response to receiving confirmation of the money transfer, the acquiring bank 140 determines whether the money transfer amount is available in the provider's designated account. If the money transfer amount is not available, the provider is notified (e.g., via the providing ATM 110 or through another communication channel such as a wireless phone) that the transfer cannot be completed. In one embodiment, the providing ATM 110 prompts the provider to select a different account from which to transfer the money.

If the money transfer amount is available from the selected account, the confirmation code generation module 114 generates a confirmation code. The confirmation code may be an alphanumeric code of variable length. The alphanumeric code can be seemingly random in nature (e.g., AX1258), or it can be non-random in nature. For example, a non-random code may be a word such as “pumpernickel.” Such non-random codes are useful, since they may be easier for the provider to remember. Regardless of the type of confirmation code that is provided, the providing ATM 110 may provide the confirmation code to the provider as a print out or on a visual display. The confirmation code could also be sent to the provider's wireless phone, or could automatically be sent to the requester's wireless phone or some other device that is operated by the requester. If the confirmation code is not automatically sent to the requester, the provider contacts the requester (e.g., by phone, email, text message, etc.) to provide the confirmation code to the requester.

The requester then accesses the requesting ATM 120 at a second location in a conventional manner using a portable consumer device such as a debit card or a credit card and the corresponding security code (e.g., a personal identification number, a phone number, a zip code, etc.). In one embodiment, the requester is required to access the requesting ATM 120 using the portable consumer device corresponding to the requester identifier (e.g., the debit or credit card identified by the CVV or having the portion of the account number that the provider used to identify the requester). The verification module 122 confirms the identity of the requester based on a corresponding verification code (e.g., a personal identification number).

As noted above, a time period may have been initiated when the provider first accessed the providing ATM 110. If the predetermined time period that was initiated when the provider initiated the money transfer has elapsed by the time the requester accesses the requesting ATM 120, the money transfer transaction will not be completed. This feature enhances security due to theft or fraud. In one embodiment, the predetermined time period is one to three hours, or less than one hour or less than three hours.

If the predetermined time period has not elapsed by the time the requester accesses the requesting ATM 120, the requester selects an indicator (e.g., “Money Transfer” or “Receive Funds”) from a main screen on the requesting ATM 120 to complete the money transfer. The requesting ATM 120 then prompts the requester for the confirmation code and, optionally, an additional security code. In one embodiment, the additional security code corresponds to the requester identifier (e.g., the last four digits of the requester's social security number, the requester's phone number, the requester's zip code, etc.). The requester then provides this information to the requesting ATM 120 using, for example, a keypad on the requesting ATM 120.

After the verification module 120 verifies the requester, the requester is notified via the requesting ATM 120 of the amount of money that has been transferred from the provider. The requesting ATM 120 then prompts the requester to select where the funds are to be transferred (e.g., a checking account, a savings account, a credit account, etc.). Alternatively, the requester may select to receive the transferred amount immediately from the requesting ATM 120 as cash. After the requester selects the destination for the transferred funds, the money is transferred from the acquiring bank 130 to the issuing bank 140 in accordance with the selected destination.

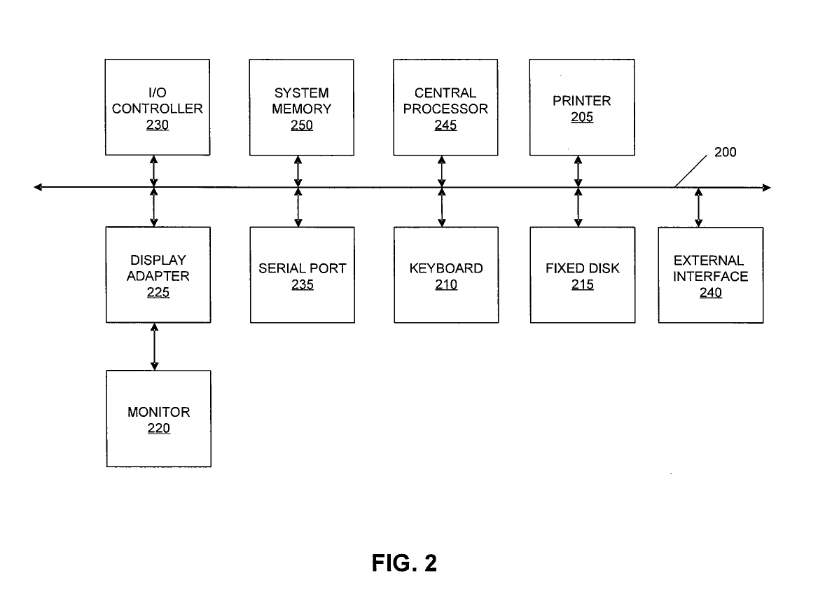

FIG. 2 shows a block diagram of some components of the central computer 100 according to an embodiment of the invention. Any of the elements in the money transfer system, such as a server computer, may utilize any suitable number of the components. The components shown in FIG. 2 are interconnected via a system bus 200. Additional subsystems such as a printer 205, keyboard 210, fixed disk 215, monitor 220, which is coupled to display adapter 225, and others are shown. Peripherals and input/output (I/O) devices, which couple to I/O controller 230, can be connected to the computer system by any number of means known in the art, such as serial port 235. For example, serial port 235 or external interface 240 can be used to connect the computing device to a wide area network such as the Internet, a mouse input device, or a scanner. The interconnection via system bus 200 allows the central processor 245 to communicate with each subsystem and to control the execution of instructions from system memory 210 or the fixed disk 215, as well as the exchange of information between subsystems. System memory 250 and/or the fixed disk 215 may embody a computer readable medium.

The results of any part of the methods according to embodiments of the invention may be output on any of the output devices shown in FIG. 2 and may be used by the entities operating the output devices. For example, an acquiring bank may have a printer or monitor, which will allow the acquiring bank to review the number of money transfer transaction completed by a provider over a given time period.

FIG. 3 shows a block diagram of some components of the automated banking machine (i.e., the providing ATM 110 or the requesting ATM 120) according to an embodiment of the invention. An exemplary automated banking machine may include a processor 300, a computer readable medium 310, a keypad 320, a portable consumer device reader 330, an output device 340, a network interface 350, and a bill reader 360 for reading bills, all of which may be operatively coupled to the processor 300. Exemplary portable consumer device readers can include RF (radio frequency) antennas, magnetic stripe readers, etc., that interact with the portable consumer device. Suitable output devices may include displays and audio output devices. Exemplary computer readable media may include one or more memory chips, disk drives, etc.

The computer readable medium 310 may store code for instructions that allow the automated banking machine to operate. The instructions may be executed by the processor 300. For example, the computer readable medium 310 may include code or instructions for sending a transaction authorization request message to an issuer of a portable consumer device to be used by a user from an automatic banking machine after receiving tender from a user. The issuer thereafter authorizes or does not authorize the transaction authorization request message. The automatic banking machine is in operative communication with a payment processing network. The computer readable medium 310 may also include code or instructions for receiving at the automatic banking machine an indication that the transaction authorization request message has been approved or not approved. The computer readable medium 310 may also have code or instructions for accepting tender and for automatically determining the amount of the accepted tender.

The bill reader 360 is capable of reading bills and distinguishing the value of the bills. It can determine if the user has inserted, for example, a $20 or $100 bill into the automated banking machine. The bill reader 360 may be more generically referred to as a tender reader. Tender readers may include bill readers, check readers, coin readers, etc. Tender readers can determine the value of tender that a user has inserted into the automated banking machine.

The network interface 350 may allow the automated banking machine to send and receive messages from an acquirer, a payment processing network, and/or an issuer.

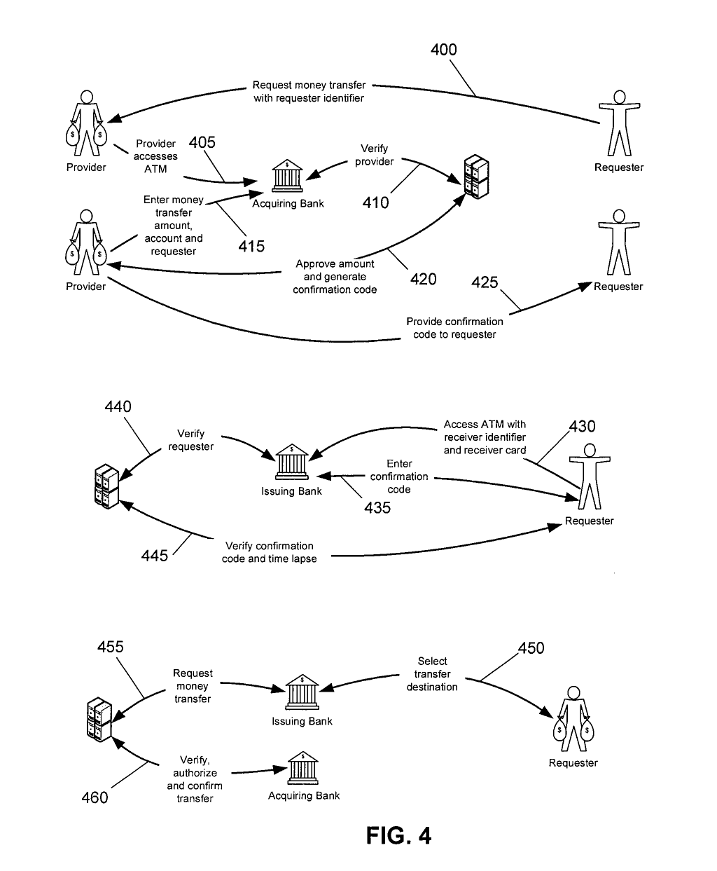

FIG. 4 shows a diagram of a process for transferring money from a first automated banking machine to a second automated banking machine according to an embodiment of the invention. The requester initiates the money transfer by contacting the provider (e.g., by phone, email, text message, etc.) and requesting an amount of money. The requester also provides the provider with one or more requester identifiers (operation 400). For example, the requester identifier may be at least a portion of the requester's account number such as the last four digits of the account number of requester's debit or credit card; a security code associated with the requester's debit or credit card (e.g., CVV); or at least a portion of a requester identification number such as the last four digits of the requester's social security number, the requester's phone number, the requester's street address, the requester's zip code, etc.

The provider then accesses an ATM associated with the acquiring bank at a first location using a portable consumer device such as a valid credit card or a debit card, a key fob, a wireless phone, a PDA, a laptop computer, etc. (operation 405). A central computer associated with the acquiring bank verifies the identity of the provider by, for example, receiving and checking the validity of at least one security code (e.g., a personal identification number and/or the last four digits of provider's social security number) (operation 410).

After the provider is verified, the provider initiates the money transfer at the ATM associated with the acquiring bank by entering the amount to be transferred, the account to transfer the money from and the requester identifier (operation 415). When the provider initiates the money transfer, a predetermined time period may be initiated. The time period may limit the amount of time that the requester has to obtain the amount of money that is transferred by the provider.

The acquiring bank determines whether the money transfer amount is available in the provider's designated account. If the money transfer amount is not available, the transfer cannot be completed. If the money transfer amount is available from the selected account, the central computer approves the amount and generates a confirmation code (operation 420). In one embodiment, the ATM associated with the acquiring bank provides the confirmation code to the provider as a print out or on a visual display. The provider then contacts the requester (e.g., by phone, email, text message, etc.) to provide the confirmation code to the requester (operation 425).

The requester accesses an ATM associated with the issuing bank at a second location using a portable consumer device and the corresponding security code (e.g., a personal identification number, a phone number, a zip code, etc.) (operation 430). In one embodiment, the requester is required to access the ATM using the using the portable consumer device corresponding to the requester identifier (e.g., the debit or credit card identified by the CW or having the portion of the account number that the provider used to identify the requester in operation 415). The requester may also be required to enter the requester identifier to access the ATM.

After initially accessing the ATM, the requester enters the confirmation code received from the provider (operation 435). The requester may enter the confirmation code using a keypad on the ATM. The central computer verifies the identity of the requester based on, for example, the requester's debit/credit card, the corresponding security code and/or the requester identifier (operation 440). The central computer also verifies the confirmation code and whether the predetermined time period has elapsed (operation 445). If the predetermined time period that was initiated when the provider initiated the money transfer has elapsed by the time the requester accesses the ATM, the money transfer transaction will not be completed.

If the predetermined time period has not elapsed by the time the requester accesses the ATM, the requester selects a money transfer destination (operation 450). For example, the requester may select a checking account, a savings account or a credit account associated with the issuing bank. Alternatively, the requester may select to receive the transferred amount from the ATM as cash. After the requester selects the destination for the transferred funds, the central computer requests the acquiring bank to transfer the money to the selected destination associated with the issuing bank (operation 455). The money transfer is then verified, authorized and confirmed by the acquiring bank (operation 460).

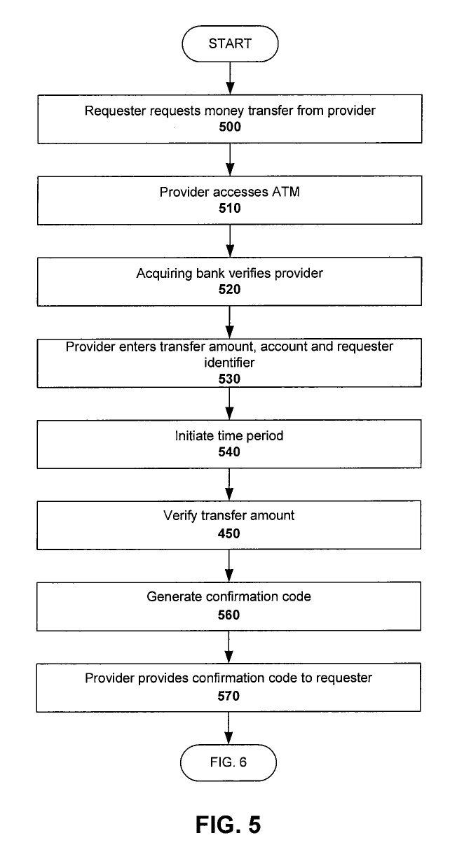

FIG. 5 shows a flowchart illustrating a method for initiating a money transfer at an automated banking machine according to an embodiment of the invention. The requester initiates the money transfer by contacting the provider (e.g., by phone, email, text message, etc.) and requesting an amount of money (operation 500). The requester also provides the provider with one or more requester identifiers. For example, the requester identifier may be at least a portion of the requester's account number such as the last four digits of the account number of requester's debit or credit card; a security code associated with the requester's debit or credit card (e.g., CVV); or at least a portion of a requester identification number such as the last four digits of the requester's social security number, the requester's phone number, the requester's street address, the requester's zip code, etc.

The provider then accesses an ATM associated with an acquiring bank using a portable consumer device such as a valid credit card or a debit card, a key fob, a wireless phone, a PDA, a laptop computer, etc. (operation 510). The acquiring bank verifies the identity of the provider by, for example, determining the validity of at least one security code such as a personal identification number or the last four digits of the provider's social security number (operation 520).

The provider enters the amount of money to be transferred, the account to transfer the money from and the requester identifier using, for example, a keypad on the ATM (operation 530). When the provider initiates the money transfer, a predetermined time period may be initiated (operation 540). The time period may limit the amount of time that the requester has to obtain the amount of money that is transferred by the provider.

The acquiring bank verifies the amount to be transferred by determining whether the money transfer amount is available in the provider's designated account (operation 550). If the money transfer amount is not available, the transfer cannot be completed. If the money transfer amount is available from the selected account, a confirmation code is generated and provided to the provider (operation 560). The provider then contacts the requester (e.g., by phone, email, text message, etc.) to provide the confirmation code to the requester (operation 570).

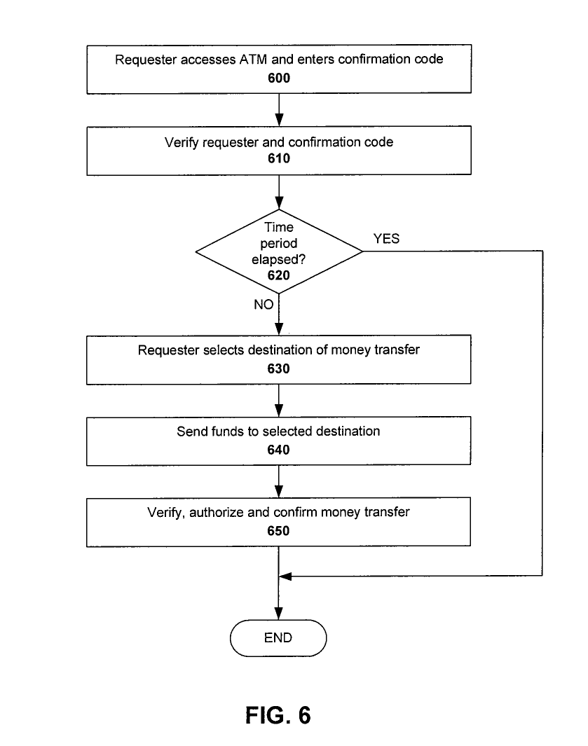

FIG. 6 shows a flowchart illustrating a method for using an automated banking machine for accessing transferred money according to an embodiment of the invention. The requester accesses an ATM in a conventional manner using a portable consumer device, and enters the confirmation code (operation 600). In one embodiment, the requester is required to access the ATM using the portable consumer device corresponding to the requester identifier (e.g., the debit or credit card identified by the CVV or having the portion of the account number that the provider used to identify the requester). The requester and the confirmation code are verified to confirm the identity of the requester and the validity of the confirmation code (operation 610). The identity of the requester may be verified based on a personal identification number. The confirmation code may be verified by accessing a central database and determining whether the confirmation code corresponds to the requester based on the requester identifier.

A determination is made whether the time period that that was initiated when the provider initiated the money transfer has elapsed by the time the requester accesses the ATM (operation 620). If the predetermined time period has elapsed, the money transfer transaction will not be completed and processing terminates. If the predetermined time period has not elapsed by the time the requester accesses the ATM, the requester selects a destination where the funds are to be transferred (operation 630). For example, the requester may select a checking account, a savings account or a credit account. Alternatively, the requester may select to receive the transferred amount from the ATM as cash. After the requester selects the destination for the transferred funds, the money is transferred from the acquiring bank to the issuing bank in accordance with the selected destination (operation 640). The money transfer is then verified, authorized and confirmed by the acquiring bank (operation 650).

Embodiments of the invention have a number of advantages. In embodiments of the invention, money can be instantaneously and securely transferred using automated banking machines. Using automated banking machines to perform a person-to-person money transfer would not require the unreasonably high transaction fees associated with conventional money transfer methods. In addition, the embodiments disclosed for transferring money are inherently secure due to the conventional security methods associated with automated banking machines. Security is further enhanced by requiring additional security codes and the limited time period during which the confirmation code remains valid.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents. Moreover, one or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method of transferring funds using an automated banking machine, the method comprising:
receiving a fund amount to transfer;
receiving a requester identifier; and
providing a confirmation code, wherein:
a requester and the confirmation code are verified when the requester accesses an automated banking machine, and
the fund amount is transferred from a provider to the requester.

2. The method of claim 1, wherein in the event that a predetermined time period has elapsed before the requester and the confirmation code are verified, transfer of the fund amount is prevented.

3. The method of claim 1, further comprising verifying the provider.

4. The method of claim 1, wherein the fund amount is transferred to the requester using a requester account, the requester account being a checking account, a savings account or a credit account.

5. The method of claim 1, further comprising verifying and authorizing the transfer of the fund amount.

6. An automated banking machine comprising:
a receiving module for receiving a fund amount to transfer and a requester identifier;
a confirmation code generation module for providing a confirmation code, wherein verification of a requester and the confirmation code is attempted when the requester accesses a different automated banking machine; and
a transfer module for transferring the fund amount from a provider to the requester when the requester and the confirmation code are verified.

7. The automated banking machine of claim 6, wherein in the event that a predetermined time period has elapsed before verification of the requester and the confirmation code is attempted, transfer of the fund amount is prevented.

8. The automated banking machine of claim 6, further comprising a verification module for verifying the provider and the transfer of the fund amount.

9. The automated banking machine of claim 6, wherein the fund amount is transferred to the requester via a requester account, the requester account being a checking account, a savings account or a credit account.

10. The automated banking machine of claim 6, further comprising an authorization module for authorizing the transfer of the fund amount.

11. A method of transferring funds using a first automated banking machine and a second automated banking machine, the method comprising:
receiving a fund amount to transfer from a provider to a requester, wherein the fund amount to transfer is received from a first automated banking machine;
attempting to verify a requester and a confirmation code when the requester accesses a second automated banking machine; and
in the event that the requester and the confirmation code are verified, transferring the fund amount from the provider to the requester.

12. The method of claim 11, further comprising:
in the event that a predetermined time period has elapsed before the requester and the confirmation code are verified, preventing transfer of the fund amount.

13. The method of claim 11, further comprising verifying the provider.

14. The method of claim 11, wherein the fund amount is transferred from the provider to the requester by transferring the fund amount from a provider account to a requester account, the provider account and the requester account being selected from the group consisting of a checking account, a savings account and a credit account.

15. The method of claim 11, further comprising providing the confirmation code to the first automated banking machine.

16. A computing device coupled to a first automated banking machine and a second automated banking machine, the computing device comprising:
a receiving module for receiving a fund amount to transfer from a provider to a requester, wherein the fund amount to transfer is received from the first automated banking machine;
a verification module for attempting to verify a requester and a confirmation code when the requester accesses the second automated banking machine, and
a transfer module for transferring the fund amount from the provider to the requester when the requester and the confirmation code are verified.

17. The computing device of claim 16, wherein the transfer module is configured to prevent transfer of the fund amount when a predetermined time period has elapsed before the verification module attempts to verify the requester and the confirmation code.

18. The computing device of claim 16, wherein the verification module is configured to verify the provider.

19. The computing device of claim 16, wherein the fund amount is transferred to the requester using a requester account, the requester account being a checking account, a savings account or a credit account.

20. The computing device of claim 16, further comprising a confirmation code generation module for generating the confirmation code and providing the confirmation code to the first automated banking machine.

21. A method of transferring funds using an automated banking machine, the method comprising:
requesting a fund amount to transfer from an account associated with a provider to an account associated with a requester, wherein the fund amount request is received at a first automated banking machine;
receiving a confirmation code from the first automated banking machine; and
providing the confirmation code to the requester, wherein:
the requester and the confirmation code are verified when the requester accesses a second automated banking machine, and
the fund amount is transferred from the provider to the requester.

22. The method of claim 21, further comprising receiving a requester identifier from the requester, wherein the requester identifier identifies an account associated with the requester.

23. The method of claim 22, wherein requesting the fund amount to transfer further comprises identifying the account associated with a requester using the requester identifier.

24. The method of claim 22, wherein the requester identifier identifies a debit card or a credit card associated with the requester.

25. The method of claim 21, wherein the fund amount is transferred from a provider account associated with the provider, the provider account being a checking account, a savings account or a credit account.
